(19) United States
(12) Patent Application Publication
(10) Pub. No.: US 2014/0007487 A1
(43) Pub. Date: Jan. 9, 2014

(54) ANCHOR WITH LITTORAL ZONE APPLICATIONS

(71) Applicant: AugHog Products, LLC, Green Cove Springs, FL (US)

(72) Inventor: Michael Schwiebert, Green Cove Springs, FL (US)

(73) Assignee: AugHog Products, LLC, Green Cove Springs, FL (US)

(21) Appl. No.: 13/933,717

(22) Filed: Jul. 2, 2013

Related U.S. Application Data
(60) Provisional application No. 61/667,591, filed on Jul. 3, 2012.

(51) Int. Cl. E04H 12/22; A01K 97/10; B63B 21/26

(52) U.S. Cl. CPC E04H 12/2238; B63B 21/26; E04H 12/2269; A01K 97/10
USPC 43/21.2; 114/295; 248/532

(57) ABSTRACT

Anchor devices for maintaining the position of marine vessels, fishing rods, umbrellas, and other items are disclosed. In an aspect, an anchor device configured for use in or near a littoral zone is disclosed comprising an auger and a body. The auger is a conical, helical screw blade constructed of a composite material or other rigid substance chosen to limit damage to individuals and equipment. The body is configured to connect to a marine vessel, thereby providing a shallow water anchor for the vessel. In another aspect, the body is configured to connect to and anchor fishing poles, signs, umbrellas, and the like.

### CROSS-REFERENCE TO RELATED APPLICATION

This application claims the benefit of U.S. Provisional Patent Application No. 61/667,591, filed Jul. 3, 2012, and entitled “Improved Anchor With Littoral Zone Applications,” the entire contents of which is incorporated herein by reference.

### FIELD OF THE DISCLOSURE

The present disclosure relates to marine accessories and more particularly to anchoring systems.

### BACKGROUND

Many devices have been traditionally used to secure items to the ground. These anchor devices are often difficult to initially set up. For example, manual hammering is required to drive an anchor post into the ground. Fluke-type boating anchors must be cast into the water and pulled across the bottom in order to properly set. The anchor may fail to set, requiring the user to haul the anchor up and reposition it for another attempt. Furthermore, if the user does not notice that the anchor device has failed to set the boat will not be secure.

Traditional anchor devices may also provide insufficient holding power and theft construction (i.e. sharp, ground penetrating spikes and blades) may increase risk of injury to the user and damage the user's equipment.

As described below, additional abilities and limitations are present in particular types of anchor devices such as boat anchors, fishing rod holders, umbrella holders, and anchors designed to restrain animals.

### Boat Anchors

Conventional boat anchors comprise a flexible connection, such as a chain, connected on one end to the vessel and connected on another end to a mass. The mass sinks to the bed of the body of water. The mass portion of the anchor maintains the attached vessel in place via its inertia and contact with the bottom of the body of water.

Because the mass portion of anchors is configured to sink to the bottom of a body of water, it is often difficult for individuals walking in the vicinity of the anchor to see the submerged portion of the anchor. This often leads to injury when individuals inadvertently walk into or trip over submerged portions of an anchor. The mass portion of an anchor is designed to sink to the bottom of a body of water; if it becomes detached from the flexible connection, the mass portion is often recovered with great difficulty or permanently lost.

Conventional anchor devices are constructed of metal. Anchor devices constructed of metal are more likely to scratch, dent, puncture, or otherwise damage the deck of a marine vessel if the anchor is inadvertently dropped or is dislodged is rough conditions. Anchors constructed of metal pose similar risks to vessel crew and passengers.

Some mass portions of an anchor device are configured to “catch” on undersea obstacles, but must slide along the bottom of the body of water before doing so. If there is not a suitable bottom feature in the path the anchor slides, the anchor may slide a significant distance before contacting an obstacle.

When anchoring a boat in shallow waters (e.g., near a beach, in a creek, and the like), it is important to secure the boat in a precise position where the boat will not be damaged. Vessel positioning is important in other shadow water environments such as beaches, rivers, creeks, lakes, and other bodies of water (collectively, “littoral waters” or “littoral zone”). Other vessels, including personal watercraft recreational boat and commercial vessels face challenges similar to those detailed herein.

In shallow waters, if a vessel is not secured in a precise position, it may be damaged by drifting into natural or manmade obstacles such as the sea floor, sunken trees, the shoreline, a bulkhead, a dock, or another vessel. The wakes of passing vessels may also push the anchored boat into these natural or manmade obstacles.

Shadow water areas often experience changes in water depth as the tide goes in and out. As the tide goes out, anchored boats may be beached or otherwise damaged if theft anchor devices don't prevent them from drifting into waters where the low tide depth is less the boat's draft.

### Mounts for Fishing Rods, Umbrellas, and the Like

Fishing rod holders typically comprise a hollow cylinder and a ground penetrating portion. Fishing rod holders are used to temporarily hold fishing rods after theft lures have been cast into the water. These fishing rod holders may be utilized near littoral waters. In addition to fishing poles, similar holders may be configured to temporarily support umbrellas and banners.

The hollow cylinder portion may be configured to temporarily secure a fishing rod or umbrella to the ground.

The ground penetrating portion may be an end portion of the cylinder cut at an angle which facilitates piercing the ground. The ground penetrating portion may be pushed into the sand of a beach or the ground of a creek shoreline. Other ground penetrating portions of other anchor devices may be an elongated metal spike, a blade, or another hollow portion.

These anchor devices are driven into a surface such as a lawn or beach. Conventional devices are driven in by manually hammering or pounding the device into the surface.

Many conventional anchor devices used to support umbrellas and the like provide little resistance against inadvertent removal from the ground. For example, a ground penetrating spike initially secures the anchor device to the ground, but does not provide resistance against the umbrella pulling itself out of the ground when the umbrella is caught by the wind because the spike is easily pulled from the cavity it created in the ground when it was initially inserted into the ground.

Given the foregoing, improved devices for facilitating a secure, temporary connection to a surface are needed. In particular, devices which facilitate making an maintaining a secure connection upon initial deployment are needed. Additionally, devices which reduce risk of injury to the user and reduce risk of damage to the user's equipment are needed.

### SUMMARY

This Summary is provided to introduce a selection of concepts in a simplified form that are further described below in the Detailed Description. This Summary is not intended to identify key features or essential features of the subject matter, nor is it intended to be used to limit the scope of the subject matter.

This disclosure addresses the above-described situation by providing anchors devices for maintaining the position of marine vessels, fishing rods, umbrellas, and other items. In some aspects, anchors are configured for use in or near littoral zones.

Anchors in accordance with this disclosure comprise an auger and a body. The auger is configured to penetrate the ground to a desired depth for stabilizing the anchor. In an aspect, the auger is a conical, helical screw blade constructed of composite material. Among other things, the anchor body may be configured to connect to and anchor vessels, fishing poles, signs, or umbrellas.

The auger is configured to stabilize the anchor and prevent the anchor from being separated from the ground it has penetrated. Anchored objects may pull against the anchor from a variety of angles. For example, an anchored vessel may drift with the current and pull against the anchor from a location other than the vessel's initial location when the anchor was set. Because the auger is configured as a conical, helical screw blade, the wider base of the auger and helical shape of the auger provide more surface area to grip the ground and resist inadvertent removal of the anchor.

In an aspect, an anchor is configured to anchor boats in shallow waters. The anchor is positively or neutrally buoyant and primarily constructed of a polymer or polymer composite. Polymer construction increases durability of the anchor while reducing wear and tear on other equipment and on users of the anchor.

In an aspect, anchor further comprises a channel configured to facilitate drainage of water, mud, sand, and other foreign objects which may flow into the anchor's interior while the anchor is in use.

In other aspects, one or more anchors are configured for placement and use as barrier poles. Such anchors may be positioned around a desired area and police tape or another barrier may be erected between the anchors. In this manner, one or more anchors may be used to designate a hazardous area or create a barrier around an area. Such barriers may be erected by private individuals or by firefighters, law enforcement, utility workers, or military personnel.

In another aspect, one or more anchors are configured for placement and use as sign anchors. The sign anchor body is configured to receive a rigid or flexible banner, flag, or other display and to support the sign anchor body. The height of the sign anchor may be adjusted to achieve the desired presentation of the sign and it may be placed on and or in a littoral zone.

In other aspects, multiple anchors are positioned to support a table top.

In other aspects, the anchor is configured as a post for cross tying horses.

In another aspect, two anchors may be placed in the ground and spaced a distance apart. The distance may be chosen to allow a volleyball net to be strung between the two anchors.

In yet another aspect, the anchor is configured for receiving an animal leash. The leash may be removably attached to the anchor, providing a restraint for the animal in non-fenced environments and where it is desirable to confine the animal to a smaller one within a bounded area.

Further features and advantages of the devices disclosed herein, as well as the structure and operation of various aspects of the present disclosure, are described in detail below with reference to the accompanying figures.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a side view of an anchor, in accordance with the present disclosure.

FIG. 2 is a detail view of an auger portion of an anchor, in accordance with the present disclosure.

FIG. 3 is a side view of a disassembled anchor, in accordance with the present disclosure.

FIG. 4 is a side view of another aspect of an anchor, in accordance with the present disclosure.

FIG. 5 is an illustration of utilizing an anchor to maintain the position of a vessel, in accordance with the present disclosure.

FIG. 6 is an illustration of utilizing anchors to maintain the position of a vessel, in accordance with the present disclosure.

FIG. 7 is an illustration of an anchor deployed on a beach, in accordance with the present disclosure.

FIG. 8 is a side view of a disassembled anchor configured to receive multiple fishing rods, in accordance with the present disclosure.

FIG. 9 is a perspective view of an assembled anchor configured to receive multiple fishing rods, in accordance with the present disclosure.

FIG. 10 is a side view of several anchors configured to support an umbrella, in accordance with the present disclosure.

FIG. 11 is a perspective view of an anchor configured to support an umbrella deployed on land, in accordance with the present disclosure.

FIG. 12 is a perspective view of an anchor configured to support an umbrella deployed in shallow water, in accordance with the present disclosure.

FIG. 13 is a perspective view of an anchor configured to receive a fishing rod, in accordance with the present disclosure.

FIG. 14 is a perspective view of two anchors configured to receive a fishing rod deployed on a beach, in accordance with the present disclosure.

### DETAILED DESCRIPTION

The present disclosure is directed to anchors for maintaining the position of marine vessels, fishing rods, umbrellas, and other items. In some aspects, anchors are configured for use in or near littoral zones.

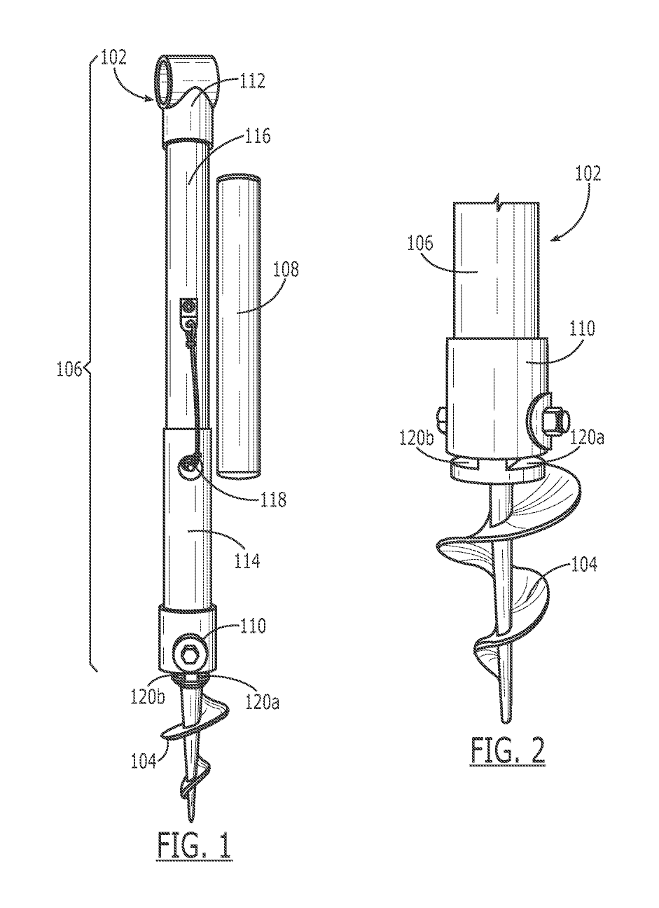

Referring now to FIGS. 1 through 3, a side view of anchor 102, a detail view of anchor 102, and a side view of a disassembled anchor 102, in accordance with the present disclosure, are shown.

Anchor 102 comprises auger 104 and body 106. In an aspect, at least a portion of anchor 102 is constructed of UV-resistant polyvinylchloride. In another aspect, at least a portion of anchor 102 is constructed of corrosion resistant materials, such as fiberglass, composite, or stainless steel.

Auger 104 is a rigid member configured to penetrate a variety of surfaces including lake bottoms, river bottoms, the sea floor, beaches, shorelines, and lawns. Auger 104 may be configured for use in any soil type. Auger 104 comprises a penetrating portion and a connector portion. Penetrating portion is configured to temporarily or permanently secure anchor 102 to a desired surface. Connector portion is configured to permanently or removably attach auger 104 to body 106. Auger 104 may be configured for use in land-based environments, water environments, and littoral environments.

Auger 104 is configured to penetrate a surface and hold anchor 102 in a desired orientation, such as a vertical orientation. Auger 104 penetrating portion is a conical, helical screw blade constructed of composite configured to penetrate sand, mud, or soil to a depth of approximately twelve inches and hold anchor 102 in a desired near-vertical orientation. As shown in FIG. 2, the edges of auger's screw blade and auger tip are blunted in order to reduce risk of damage to equipment and users.

Auger 104 penetrating portion is configured to penetrate a surface and temporarily or permanently secure anchor 102 to the surface. Auger 104 is configured to resist removal from the surface when anchored objects pull against anchor 102 from a variety of angles. For example, where auger 104 penetrating portion is a conical, helical screw blade, the wider base of auger 104 and helical shape of auger 104 provide more surface area to grip the surface and resist inadvertent removal of the anchor 102 by the anchored object (e.g., a drifting vessel, an animal, a windblown umbrella, a volleyball net, and the like).

The conical, helical design of auger 104 allows the user to remove deployed anchor 102 from the surface by rotating the anchor in the opposite direction used to initially deploy anchor 102.

Auger 104 connector portion further comprises one or more drainage channels 120 (shown, for clarity, as drainage channels 120a-b in FIGS. 1 and 2). Drainage channel 120 is configured to allow solids and liquids which may become lodged inside anchor 102 to escape. In an aspect, connector portion is a composite cylinder comprising drainage channels 120 along the length of the cylinder. Drainage channel is open on an end portion (not shown) of connector portion proximal to body 106, and configured to allow solids and liquids to flow or move into drainage channel 120. Drainage channel 120 is configured to allow solids and liquids to flow or move out of drainage channel at an end portion located on a distal portion of connector portion of auger 104. A drainage channel 120 may be placed in each quadrant of the connector portion. Placement of multiple drainage channels 120 facilitates escape of solid debris and liquids and reduces the likelihood of soils or liquids becoming trapped within anchor 102.

Body 106 comprises at least one rigid member. In an aspect, body 106 is comprised of polyvinylchloride pipe which extends away from auger 104. Body 106 is permanently connected on a proximal portion to auger 104 at auger connector portion. Permanent connection may be a solvent weld between polymer portions of body 106 and auger 104. Body 106 comprises a distal portion configured to temporarily secure a vessel in littoral waters. In some aspects, body 106 is several feet long. In some aspects, the length of body 106 is chosen such that anchor 102 may be secured to the bottom of a body of water and distal portion of anchor 106 is above the surface of the body of water. This enables anchor 106 to be seen and easily used to secure a vessel.

In another aspect, body 106 comprises a six foot long polyvinylchloride pipe configured to attach a volleyball net (not shown in FIG. 20. Two anchors 102 may be inserted into the ground via auger 104 and spaced a sufficient distance apart to support the volleyball net (i.e., thirty to thirty-six feet for a full sized net). The volleyball net may be removably connected to each anchor 103 via inserting a top portion of body 106 into a sleeve of volleyball net.

In some aspects, anchor 102 is configured for positive or neutral buoyancy. Positive or neutral buoyancy enables anchor 102 to be easily recovered if it is dropped into a body of water because anchor 102 will float on or near the surface of the water. In an aspect, body 106 is a rigid member comprising a hollow, sealed cavity. The volume of the cavity is chosen to make anchor 102 float. In another aspect, cavity is at least partially filled with foam and configured to make anchor 102 float. Such foam may comprise polyurethane, floatation foam, and the like. In an aspect, foam comprises channels configured to allow liquid and solids to flow within anchor 102, allowing liquid and solids to escape anchor 102.

Body 106 is configured to anchor a vessel by receiving an anchor line from the vessel. Body 106 further comprises a receiver 112. Receiver 112 is connected to body 106 on a distal portion of body 106 and may be visible and accessible when anchor 102 is secured to the bottom of a body of water. Receiver 106 is a rigid loop, cylinder, or circle configured to allow an anchor line to be run through receiver 106 and tied off, temporarily securing the vessel to anchor 102 and restricting movement of the vessel. In another aspect (not shown), receiver 112 is an eye bolt. Vessels may be connected to anchor 102 via a quick release connector in lieu of tying a knot in the anchor line. In another aspect (not shown), receiver 112 is another device configured to removably attach to a vessel such as a cleat, a cam cleat, a spar cleat, a jam cleat, carabineer, or other device.

Anchor 102 further comprises a handle 108. In an aspect, handle 108 is a rigid bar configured to removably attach to a portion of anchor 102. Handle may be used to rotate anchor 102 when it contacts a surface, thereby engaging auger 104 and penetrating the surface via the boring action of the auger 104. In an aspect, body 106 comprises an insertion point configured to receive handle 108. Insertion point may be at least one hole or notch in body 106 configured to allow handle 108 to slide into body 106 and remain secured to body 106 as anchor 102 is rotated via handle 108. In an aspect, insertion point and receiver 112 are the same. That is, receiver 112 may be used to receive an anchor line or some other device for securing a vessel and is also configured to receive handle 108.

Handle 108 may be inserted into anchor 102 at insertion point. In this configuration, an anchor line from a vessel or some other device for securing a vessel may be removably attached to anchor 102 at handle 108 or another portion of anchor 102.

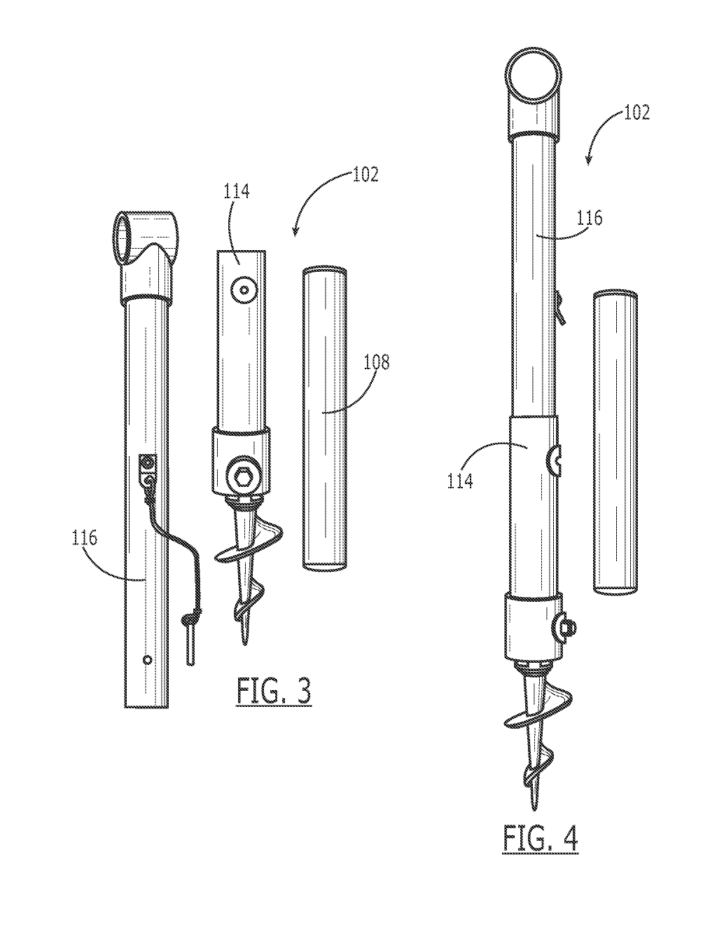

In an aspect, anchor 102 comprises at least one removable portion. Anchor 102 may comprise removable portions in order to change or reduce the volume of space required to store anchor 102 when anchor 102 is not in use. In marine applications, anchors 102 comprising removable portions, such as the anchor 102 depicted in FIG. 3, may be stowed in a small onboard compartment.

Body 106 comprises an upper portion 116 and a lower portion 114.

Lower portion 114 is a vertically oriented rigid cylinder and comprises a proximal portion and a distal portion. In an aspect, proximal portion of lower portion 114 further comprises reinforcement ring 110. Reinforcement ring 110 is a ring configured to provide additional strength at body 106 connection portion with auger 104. Proximal portion of lower portion 114 is connected to auger 104 at auger connector portion. Distal portion of lower portion 114 is removably attached to upper portion 116. In an aspect, distal portion of lower portion 114 further comprises retaining pin insertion point.

Proximal portion of body 106 further comprises a bolt assembly and bolt connection points configured to connect auger 104 to body 106.

Upper portion 116 is a vertically oriented rigid cylinder and comprises a proximal portion and a distal portion. As shown in FIGS. 1 and 3, proximal portion of upper portion 116 is tapered in order to slidably connect to lower portion 114. Upper portion 116 is inserted into distal portion of lower portion 114.

Upper portion 116 further comprises retaining pin 118. Upper portion 116 further comprises retaining pin insertion point. Retaining pin 118 is a rigid rod with diameter approximately equal to the diameter of lower portion 114 and upper portion 116 retaining pin insertion points. Upper portion 116 is inserted into lower portion 114 and retaining pin insertion points are aligned. Retaining pin 118 is inserted through upper portion 116 and lower portion 114 retaining pin insertion points, providing a physical retaining mechanism to ensure upper portion 116 and lower portion 114 stay connected while anchor 102 is in use.

Retaining pin 118 further comprises a flexible connector configured to permanently attach retaining pin 118 to a portion of anchor 102. In an aspect, flexible connector is a stainless steel braided cable connected on a distal portion to upper portion 116 and connected on a proximal portion to retaining pin 118.

Distal portion of upper portion 116 is receiver 112. In another aspect, distal portion of upper portion 116 is connected to receiver 112.

Referring briefly now to FIG. 4, a side view of another aspect of anchor 102 of FIGS. 1-3, in accordance with the present disclosure, is shown. Anchor 102 length is chosen based on application. Where anchor 102 will be used in very shallow waters or above water visibility is unimportant, short anchors 102 like those depicted in FIGS. 1 through 3 may be used. Where a vessel is anchored in deeper waters or a significant portion of anchor 102 should be above water, anchor 102 length is significantly increased, as shown in FIG. 4. In an aspect, lower portion 114 may removably connect to upper portions 116 of varying lengths, enabling the same lower portion 114 to be used in environments requiring different length anchors 102.

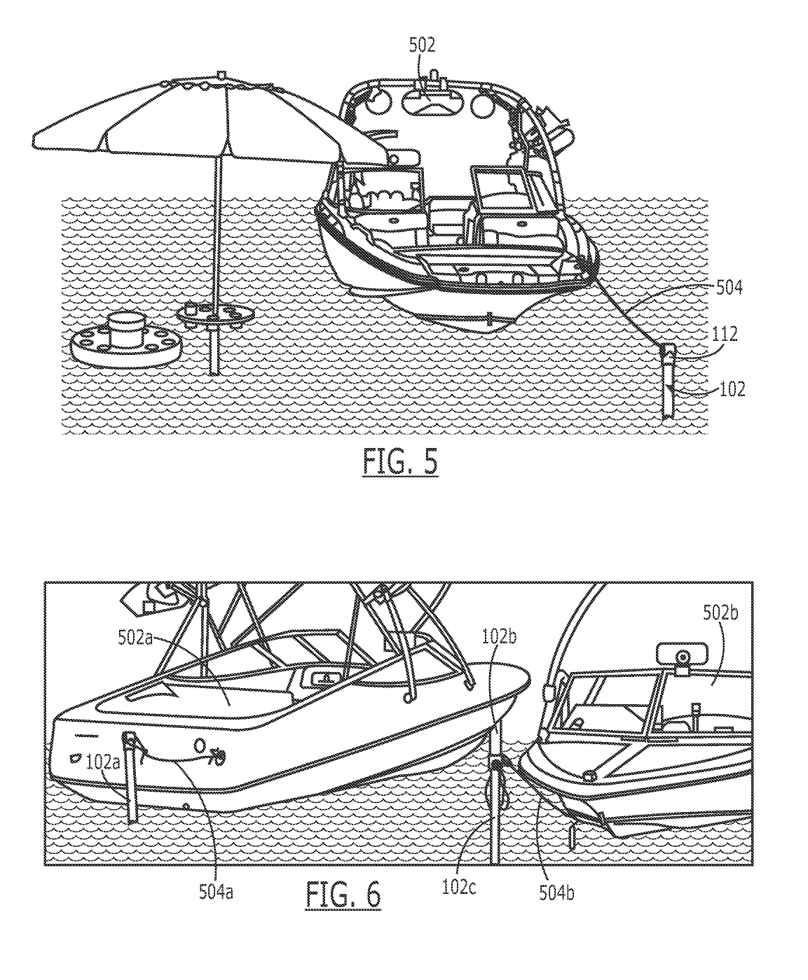

Referring now to FIG. 5, an illustration of utilizing an anchor 102 to maintain the position of a vessel, in accordance with the present disclosure, is shown.

Vessel 502, such as a ski boat, is anchored in a littoral zone using anchor 102. Anchor 102 is placed and temporarily secured to the bottom of the body of water by placing auger 104 on the bottom. Upon contact with the bottom, anchor 102 is rotated, causing anchor 102 to penetrate the bottom via the boring action of the auger 104. In an aspect, auger 104 bores down at least twelve inches, temporarily securing anchor 102 to the bottom of the body of water. Distal portion of anchor 102 comprises receiver 112. Anchor 102 is sufficiently long such that receiver 112 remains above the surface of the water when anchor 102 secured to the bottom of the body of water. Vessel 502 may be removably connected to anchor 102 via an anchor line 504 or some other device for connecting vessel 502 to anchor 102. In some aspects, anchor line 504 is connected at one portion to the bow of vessel 502 and connected on another portion to receiver 112.

Anchor 102 is at least partially constructed of a durable material such as polyvinylchloride. Anchor 102 may be placed within three feet of vessel 502. Close proximity of anchor 102 and vessel 502 facilitates precise placement and limitation of the movement of vessel 502. Anchor's 102 utilization of polyvinylchloride reduces risk of damaging vessel 502 or anchor 102 if vessel unintentionally collides with anchor 102. In an aspect, anchor 102 further comprises one or more boat bumpers configured to prevent damage to vessel 502 or anchor 102 in the event of a collision.

Referring now to FIG. 6, an illustration of utilizing an anchor 102 to maintain the position of a vessel, in accordance with the present disclosure, is shown.

Vessel 502 (for clarity, shown as vessels 502a-b in FIG. 6) may be anchored using two or more anchors 102 (for clarity, shown as anchors 102a-c in FIG. 6). As shown in FIG. 6, a first anchor 102 may be removably connected to the stern of vessel 502 and a second anchor 102 may be attached to the bow of vessel 502. Anchor lines 504 (for clarity, shown as anchor lines 504a and 504c in FIG. 6. Anchor line 504a corresponds with anchor 102a. Anchor line 504c corresponds with anchor 102c) may be short in order to restrict movement of vessel 502 and allow for vessels to be placed in dose proximity to one another without colliding.

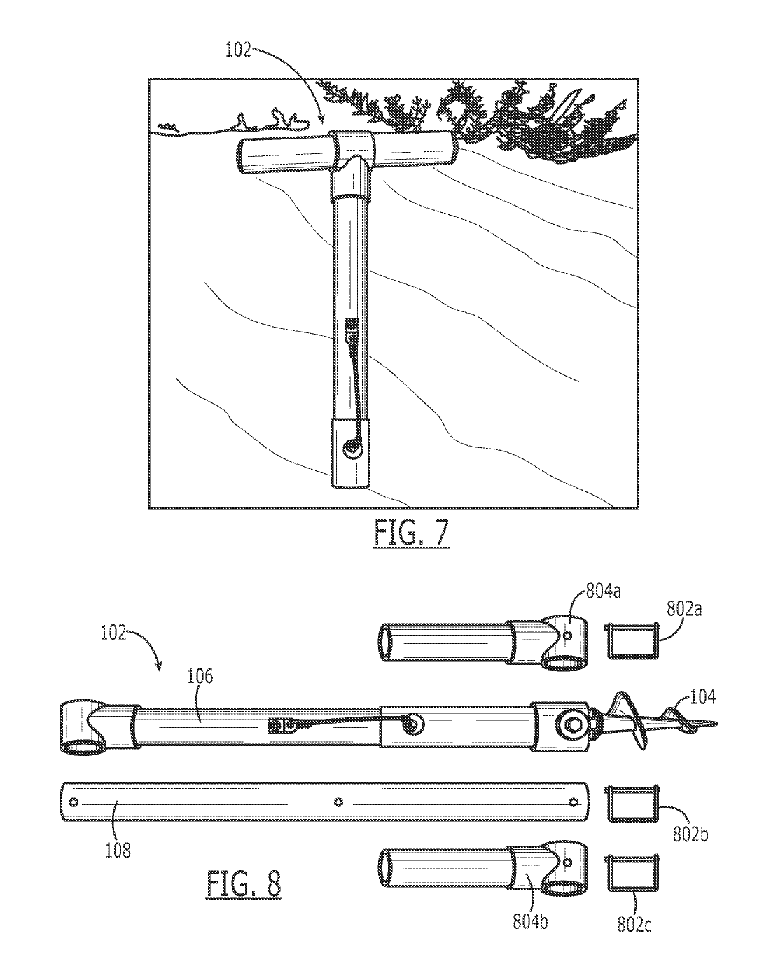

Referring briefly now to FIG. 7, an illustration of an anchor 102 deployed on a beach, in accordance with the present disclosure, is shown. Anchor 102 may be secured on a dry surface near a body of water, such as a beach. Anchor lines 504 or some other device for connecting vessel 502 to anchor 102 may be attached to anchor 102 when it is deployed on a dry surface.

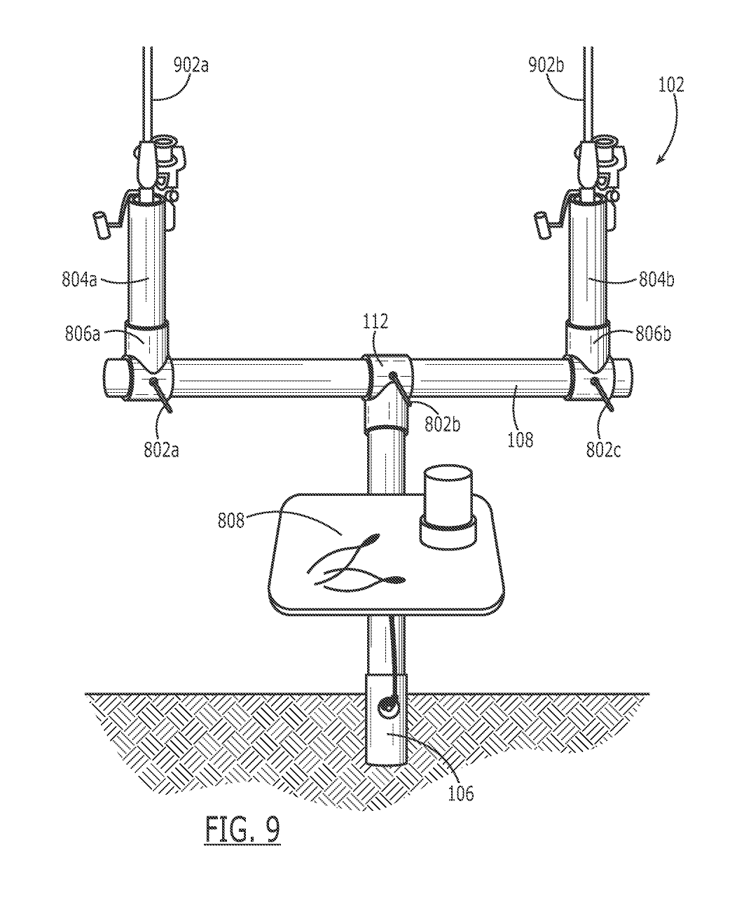

Referring now to FIGS. 8 and 9, a side view of a disassembled anchor 102, in accordance with the present disclosure, is shown.

Anchor 102 is configured as a mount for multiple fishing rods. Anchor 102 comprises auger 104, body 106, and handle 108. Handle 108 further comprises at least one mount (for clarity, shown as mounts 804a-b in FIG. 8). Handle further comprises at least one fastener 802 (for clarity, shown as fasteners 802a-c in FIG. 8). In some aspects, body 106 further comprises lower portion 114, upper portion 116, and receiver 112.

Anchor 102 is vertically oriented. Auger 104 is connected on a distal portion to a proximal portion of body 106. Handle 108 is horizontally oriented. At a distal portion, body 106 removably connects to handle 108 via slidably connecting at receiver 112.

Receiver 112 comprises one or more fastener receiving holes. At a middle portion, handle 108 comprises one or more fastener receiving holes. Handle 108 is inserted into receiver 112 and positioned such that approximately half of handle 108 protrudes from each side of receiver 112 and receiver 112 fastener receiver holes align with handle 108 fastener receiver holes. A fastener 802 comprising a rigid rod is inserted into fastener receiving holes, removably securing handle 108 to body 106.

Referring now to FIG. 9, a perspective view of an assembled anchor 102 configured to receive multiple fishing rods, in accordance with the present disclosure, is shown.

Mounts 804 are vertically oriented members configured to support one or more fishing rods 902 (shown, for clarity, as fishing rods 902a-b in FIG. 9). Mount 804 comprises a hollow cylinder with a proximal portion and a distal portion. Fishing rod 902 may be inserted into distal portion of mount 804. Proximal portion further comprises base 806 (shown, for clarity, as base 806a-b in FIG. 9). Base 806 is configured to removably and slidably connect to handle 108. Base 806 comprises one or more fastener receiving holes.

Handle 108 comprises a first end portion and a second end portion. Each end portion is configured to removably connect to mount 804 at base 806. Each end portion comprises one or more fastener receiving holes. Handle 108 is inserted into base 806 and positioned such that base 806 fastener receiver holes align with handle 108 fastener receiver holes. A fastener 802 comprising a rigid rod is inserted into fastener receiving holes, removably securing mount 804 to handle 108.

In some aspects, body 106 further comprises a platform 808. Platform 808 is removably attached to body 106 and configured to form a level surface suitable for holding small items such as lures or bait. In some aspects, platform 808 comprises a cavity configured to hold one or move beverage containers.

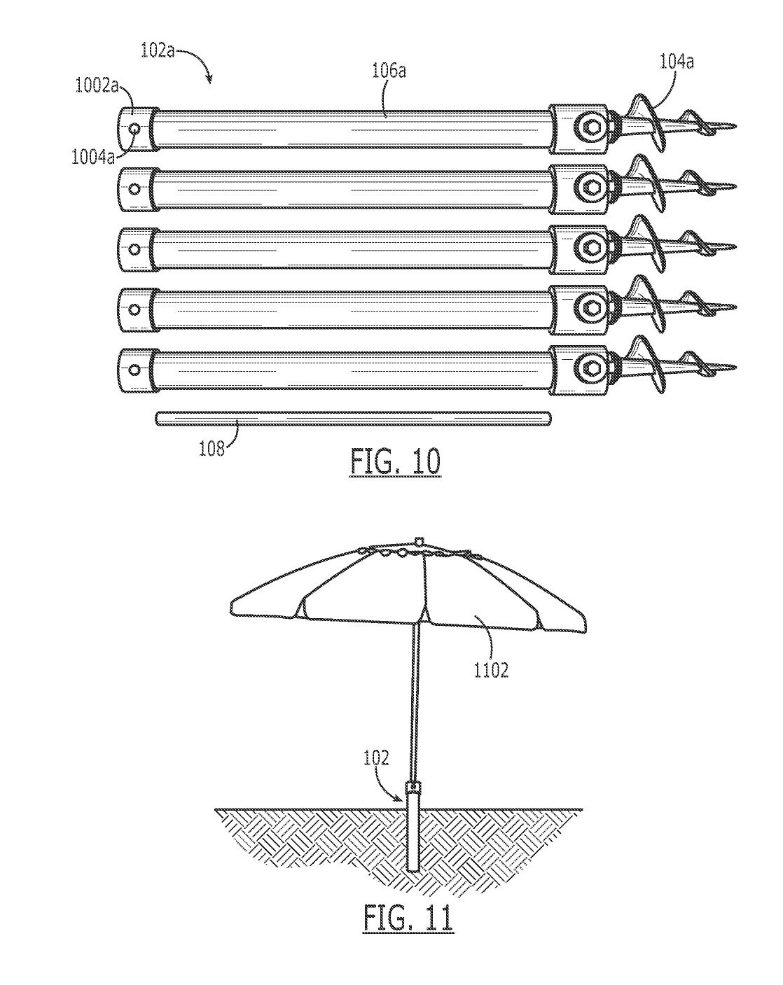

Referring now to FIG. 10, a side view of anchors 102 configured to support umbrellas, in accordance with the present disclosure, is shown.

Anchor 102 may be configured to support a beach umbrella. Anchor 102 (for clarity, shown as anchor 102a in FIG. 10) comprises auger 104 (for clarity, shown as auger 104a in FIG. 10), body 106 (for clarity, shown as body 106a in FIG. 10), and retaining ring 1002 (for clarity, shown as retaining ring 1002a in FIG. 10). Anchor 102 is removably secured to a surface and vertically oriented such that an umbrella may be inserted into anchor 102 at a distal portion of anchor 102.

Auger 104 is connected on a distal portion to a proximal portion of body 106. Body 106 is a hollow cylinder. Body 106 is connected on a distal portion to retaining ring 1002. Retaining ring 1002 is configured to removably secure an end portion of an umbrella when an end portion of an umbrella is inserted into anchor 102 via a distal portion of retaining ring 1002.

Retaining ring 1002 is a cylinder comprising a set screw 1004 (shown, for clarity, as set screw 1004a in FIG. 10) oriented along the radius of retaining ring 1002 and movable in relation to the vertical centerline of anchor 102. Umbrella is inserted into anchor 102 via a distal portion of retaining ring 1002. Set screw 1004 may be tightened such that it contacts the umbrella and removably secures the umbrella in anchor 102. In some aspects, retaining ring 1002 further comprises at least one channel, notch, or hole configured to allow insertion of handle 108. Handle 108 may be used to bore anchor 108 into a surface such as a beach or lawn.

Referring briefly now to FIG. 11, a perspective view of an anchor 102 configured to support an umbrella 1102 mounted on land, is shown. Anchor 102 may be configured for use in both and marine environments. For example, anchor 102 configured to removably secure umbrella may be deployed on a lawn or in a littoral zone.

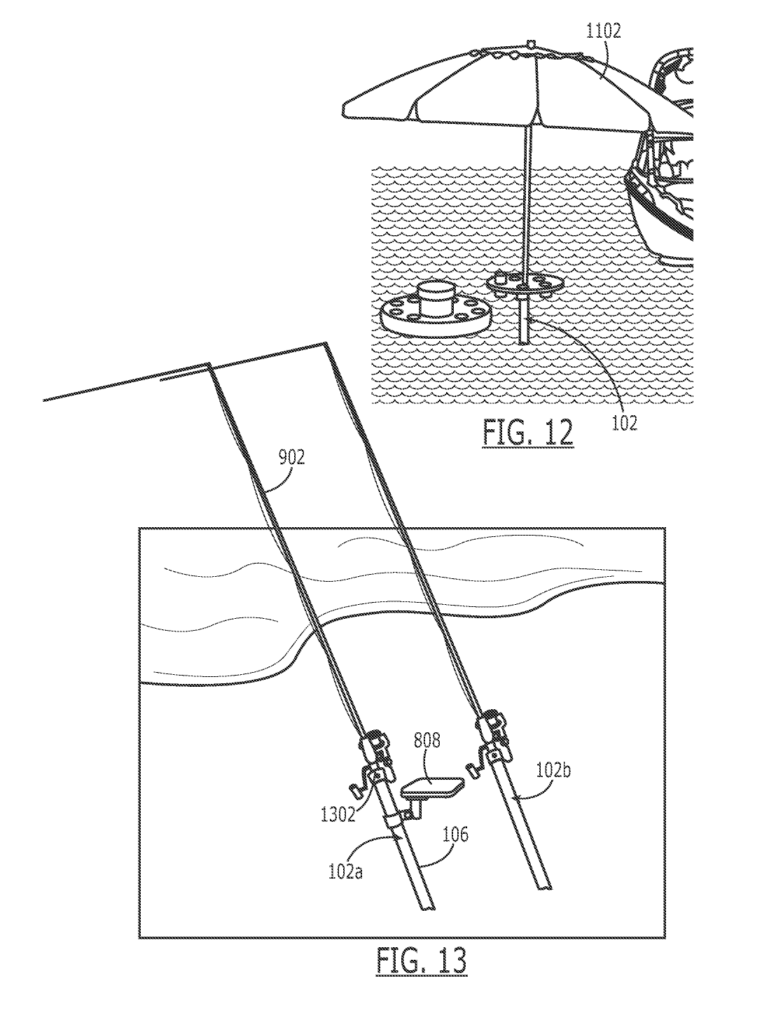

Referring briefly now to FIG. 12, a perspective view of an anchor 102 configured to support an umbrella 1102 mounted in shallow water, is shown.

Referring now to FIG. 13, a perspective view of two anchors 102 configured to receive a fishing rod 902 deployed on a beach, in accordance with the present disclosure, is shown.

Anchor 102 may be configured to support a fishing rod 902. Anchor 102 (shown, for clarity, as anchor 102a-b in FIG. 13) comprises auger 104 (not shown in FIG. 13) and body 106 (shown, for clarity, as body 106 in FIG. 13). The orientation of anchor 102 may be vertical. Anchor 102 may be oriented at another angle relative to the surface it is secured to. Orientation of anchor 102 maybe set by boring auger 104 into surface at the desired orientation angle.

Body 106 comprises a distal flared end 1302 (shown, for clarity, as flared end 1302 in FIG. 13) configured to support a fishing rod 902. Body 106 further comprises platform 808. Platform 808 is removably attached to body 106 and configured to form a level surface suitable for holding small items such as lures or bait. Platform 808 may be removably attached to body at any desired height along body 106.

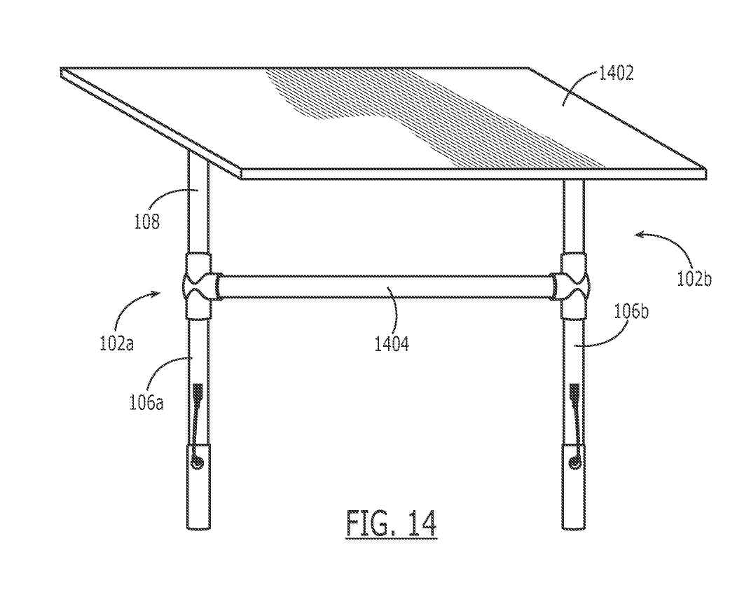

Referring now to FIG. 14, a perspective view of a pair of anchors 102 configured to support a table top 1402, in accordance with the present disclosure, is shown.

Two anchors 102 (shown, for clarity, as anchors 102a-b in FIG. 14) are spaced a distance apart. Anchor 102 comprises auger 104 (not shown in FIG. 14) and body 106 (shown, for clarity, as bodies 106a-b in FIG. 14). On a distal portion, body 106 is configured to removably connect to and support tabletop 1402. On a distal portion, body 106 further comprises at least one channel, notch, or hole configured to allow insertion of handle 108. Handle 108 may be used to bore anchor 102 into a surface such as a beach or lawn. In an aspect, anchors 102 are interconnected via a rigid stabilizer bar 1404 in order to provide additional support for tabletop 1402.

Tabletop 1402 is a level, planar surface configured for removable connection on a proximal side to one or more anchors 102. In an aspect, tabletop 1402 is a rectangular polyvinylchloride surface of approximately four feet in length. It may be configured to be used as an eating surface, a fillet table, or utility table. In another aspect, tabletop 1402 further comprises stenciled on designs or painted on designs suitable for facilitating tabletop games such as beer pong.

In another aspect, two anchors 102 are spaced a distance apart. Anchor comprises auger 104 and body 106. On a distal portion, body is configured to removably connect to and support a cooking surface. cooking surface may be a charcoal grill, a rotatable spit, a propane grill, a camp stove, and the like.

In another aspect, anchor 102 is configured to support signs. Body 106 is configured to receive a rigid or flexible banner, flag, or other display and to support the sign.

In another aspect, at least one anchor 102 is configured for placement and use as a pole. Body 106 is configured as a rigid pole suitable for supporting police tape, mesh fencing, or another barrier which may be erected between anchors 102. In this manner, one or more anchors 102 may be used to designate a hazardous area or create a barrier around an area. Such barriers may be erected by private individuals or by firefighters, law enforcement, utility workers, or military personnel.

In other aspects, anchor 102 is configured as a post for cross tying horses.

In yet another aspect, anchor is configured for receiving an animal leash. The leash may be removably attached to anchor 102, providing a restraint for the animal.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. An anchor device for maintaining the position of connected items relative to a surface, comprising:
an auger, having polymer construction, comprising:
a penetrating portion, having a conical shape, configured to removably connect with the surface; and
a connector portion, joining the penetrating portion at a penetrating
portion base, comprising a plurality of drainage channels; and
a body, extending away from the auger, having polymer construction, comprising:
a cylindrical proximal body portion, rigidly connected to the auger at the connector portion; and
a distal body portion configured to removably connect to and stabilize an item.

2. The anchor device of claim 1, wherein the penetrating portion comprises blunted edges configured to reduce accidental damage to individuals and equipment.

3. The anchor device of claim 1, wherein the penetrating portion is between four and six inches long; and
wherein the penetrating portion base is between two and four inches wide.

4. The anchor device of claim 1, further comprising:
a removable handle, removably connectable to the body at a handle insertion point portion positioned on the body;
wherein the handle is configured to facilitate insertion of the auger into the surface.

5. The anchor device of claim 4, wherein the handle is a rigid rod; and
wherein the handle insertion point portion is an opening configured to slidably receive the handle, located on the distal body portion.

6. The anchor device of claim 1, configured to maintain the position of a vessel in shallow waters, wherein the distal body portion comprises:
a receiver having an opening configured to receive an anchor line.

7. The anchor device of claim 6, further comprising:
a removable, cylindrical handle, removably connectable to the body at the receiver, the receiver being further configured to slidably receive the handle;
wherein the handle is configured to facilitate insertion of the auger into the surface.

8. The anchor device of claim 6, wherein a body length is chosen to position the receiver above the surface of the shallow water.

9. The anchor device of claim 1, further configured for positive buoyancy in freshwater.

10. The anchor device of claim 1, wherein the body further comprises further comprises:
a buoyancy portion configured to create a positive buoyancy condition in freshwater.

11. The anchor device of claim 10, wherein the buoyancy portion is a hollow sealed chamber within the body.

12. The anchor device of claim 10, wherein the buoyancy portion comprises floatation foam.

13. The anchor device of claim 1, the body further comprising:
a retainer;
wherein the distal body portion is separable from the proximal body portion; and
wherein the distal body portion may be removably connected to the proximal body portion via the retainer.

14. The anchor device of claim 1, wherein the distal body portion is configured slidably receive an umbrella pole.

15. The anchor device of claim 14, wherein the distal body portion comprises an umbrella pole retainer configured to removably retain the umbrella pole.

16. The anchor device of claim 1, wherein the distal body portion is flared; and
wherein the distal body portion is configured to slidably receive a fishing pole.

17. The anchor device of claim 1, configured to support a volleyball net having a support sleeve, wherein the distal body portion is configured to slidably insert into the support sleeve.

18. The anchor device of claim 1, wherein the surface is one of:
a sand bar;
a riverbed;
a lakebed;
a lawn; and
a beach.

19. An anchor device for maintaining the position of a vessel in shallow waters, comprising:
an auger, having polymer construction, comprising:
a penetrating portion, having a conical shape, configured to removably connect with the surface; and
a connector portion, joining the penetrating portion at a penetrating
portion base, comprising a plurality of drainage channels; and
a body, extending away from the auger, having polymer construction, comprising:
a cylindrical proximal body portion, rigidly connected to the auger at the connector portion; and
a distal body portion configured to removably connect to the proximal body portion via a retainer, comprising:
a receiver having an opening configured to receive an anchor line; and
a removable, cylindrical handle, removably connectable to the body at the receiver, the receiver being further configured to slidably receive the handle;
wherein the handle is configured to facilitate insertion of the auger.

20. The anchor device of claim 19, further configured for positive buoyancy in freshwater.
